(19) United States
(12) Patent Application Publication
(10) Pub. No.: US 2020/0115025 A1
(43) Pub. Date: Apr. 16, 2020

(54) DEFORMABLE FRAME OF AERIAL VEHICLE AND AERIAL VEHICLE

(71) Applicant: SZ DJI TECHNOLOGY CO., LTD., Shenzhen (CN)

(72) Inventor: Guibin LIANG, Shenzhen (CN)

(21) Appl. No.: 16/704,869

(22) Filed: Dec. 5, 2019

Related U.S. Application Data
(63) Continuation of application No. PCT/CN2017/099896, filed on Aug. 31, 2017.

(51) Int. Cl. B64C 1/06

(52) U.S. Cl. CPC B64C 1/063; B64C 2201/20; B64C 2201/024; B64C 2201/165; B64C 2201/108

(57) ABSTRACT

An aerial vehicle includes a deformable frame. The deformable frame includes a center frame and two arm assemblies. The two arm assemblies are disposed at two sides of the center frame respectively, and are rotatably connected to the center frame, to enable the deformable frame to switch between an unfolded state and a folded state. Each arm assembly includes a deformable rod and a cross rod. The deformable rod includes a first end rotatably connected to the center frame, and a second end rotatably connected to the cross rod and having a height larger than the first end. In the unfolded state, second ends of the deformable rods in the two arm assemblies are away from the center frame. In the folded state, the deformable rods in the two arm assemblies are stacked above the center frame. The aerial vehicle further includes a loading mounted on the center frame.

### CROSS-REFERENCE TO RELATED APPLICATION

This application is a continuation of International Application No. PCT/CN2017/099896, filed at Aug. 31, 2017, the entire content of which is incorporated herein by reference.

### TECHNICAL FIELD

The present disclosure relates to the field of aerial vehicle and, more particularly, to a deformable frame and an aerial vehicle.

### BACKGROUND

Unmanned aerial vehicles are usually required to operate at different places and be transported over a long distance. However, an unmanned aerial vehicle with propellers that protrude out of a body of the unmanned aerial vehicle is not easy to carry and transport.

### SUMMARY

One aspect of the present disclosure provides an aerial vehicle. The aerial vehicle includes a deformable frame. The deformable frame includes a center frame and two arm assemblies. The two arm assemblies are disposed at two sides of the center frame respectively, and are rotatably connected to the center frame, to enable the deformable frame to switch between an unfolded state and a folded state. Each arm assembly includes a deformable rod and a cross rod. The deformable rod includes a first end rotatably connected to the center frame, and a second end rotatably connected to the cross rod. A height of the second end is larger than a height of the first end. In the unfolded state, second ends of the deformable rods in the two arm assemblies are away from the center frame. In the folded state, the deformable rods in the two arm assemblies are stacked above the center frame. The aerial vehicle further includes a loading mounted on the center frame of the deformable frame.

Other aspects or embodiments of the present disclosure can be understood by those skilled in the art in light of the description, the claims, and the drawings of the present disclosure

### BRIEF DESCRIPTION OF THE DRAWINGS

FIG. 1 illustrates an exemplary deformable frame in an unfolded state consistent with various embodiment of the present disclosure;

FIG. 2 illustrates an exemplary deformable frame in a folded state consistent with various embodiment of the present disclosure;

FIG. 3 illustrates a magnified view of a part III of the deformable frame in FIG. 2;

FIG. 4 illustrates an exploded view of a part of an exemplary deformable frame consistent with various embodiment of the present disclosure;

FIG. 5 illustrates a top view of an exemplary deformable frame in a folded state consistent with various embodiment of the present disclosure;

FIG. 6 illustrates a side view of an exemplary deformable frame in a folded state consistent with various embodiment of the present disclosure;

FIG. 7 illustrates another side view of an exemplary deformable frame in a folded state consistent with various embodiment of the present disclosure; and

FIG. 8 illustrates another exemplary aerial vehicle consistent with various embodiments of the present disclosure.

### DETAILED DESCRIPTION OF THE EMBODIMENTS

Reference will now be made in detail to exemplary embodiments of the disclosure, which are illustrated in the accompanying drawings. Wherever possible, the same reference numbers will be used throughout the drawings to refer to the same or like parts.

Example embodiments will be described with reference to the accompanying drawings, in which the same numbers refer to the same or similar elements unless otherwise specified.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them. The terms “perpendicular,” “horizontal,” “left,” “right,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

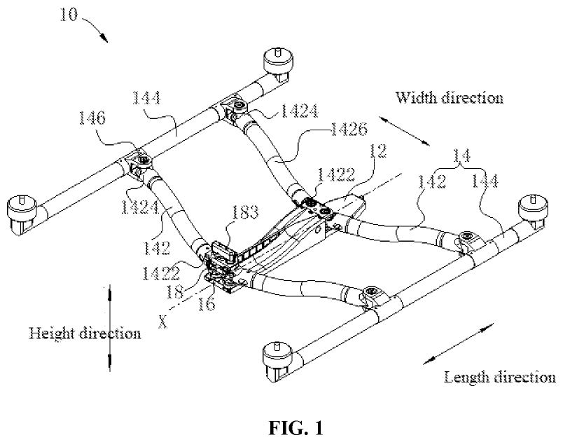

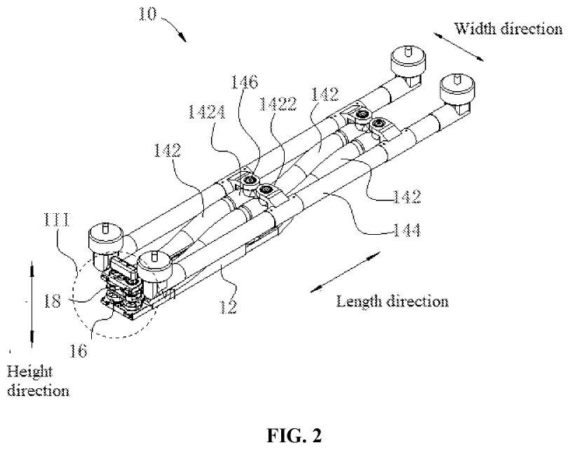

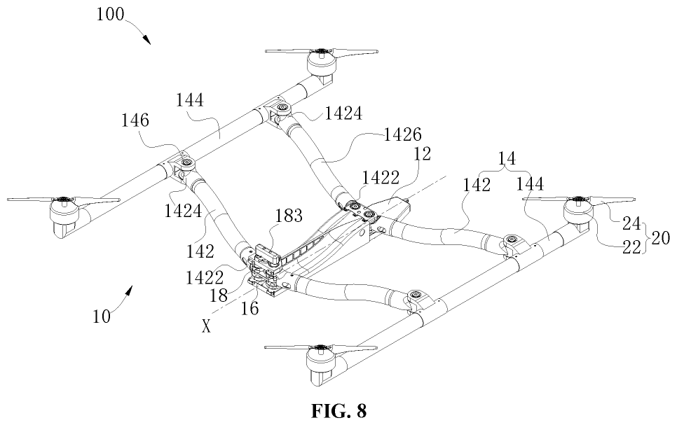

The present disclosure provides a deformable frame 10 for an aerial vehicle 100, as illustrated in FIG. 1, FIG. 2, and FIG. 8. The deformable frame 10 may include a center frame 12 and two arm assemblies 14. The two arm assemblies 14 may be disposed at two sides of the center frame 12 respectively, and may be rotatably connected to the center frame 12, to make the deformable frame switchable between an unfolded state (in FIG. 1) and a folded state (FIG. 2).

Each arm assembly 14 may include a deformable rod 142 and a cross rod 144, and the deformable rod 142 may include a first end 1422 rotatably connected to the center frame 12 and a second end 1424 rotatably connected to the cross rod 144. A height of the second end 1424 may be larger than a height of the first end 1422.

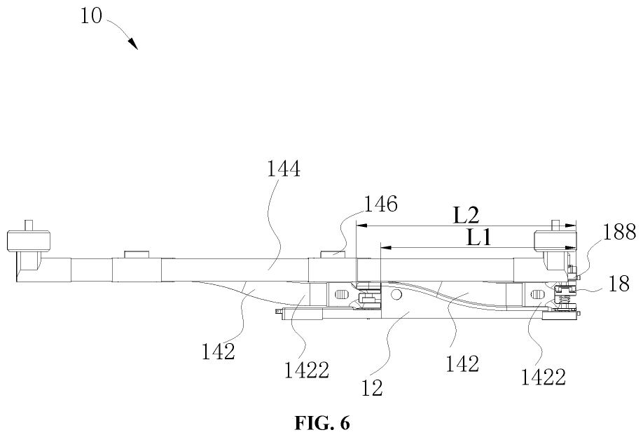

In the unfolded state, the second end 1424 of each arm assembly 14 may be away from the center frame 12; in the folded state, the deformable rod 142 of each arm assembly 14 may be stacked on the center frame 12, as illustrated in FIG. 6.

In the present disclosure, when the deformable frame 10 is switched from the unfolded state to the folded state, the deformable frame 10 may be folded to a stacking structure. The folded deformable frame 10 may occupy a small volume and can be folded easily. Correspondingly, the folded deformable frame 10 may be easy to carry and transport.

In one embodiment, when the deformable frame 10 is switched from the unfolded state to the folded state, the deformable rod 142 of each arm assembly 14 may be stacked above the center frame, and the cross rod 144 of each arm assembly 14 may be abutted against the deformable rod 142 and may be disposed at one side of the deformable rod 142 respectively. The folded deformable frame 10 may occupy a small volume.

In one embodiment, the deformable rod 142 of each arm assembly 14 may be generally linear, and may be disposed obliquely with respect to the center frame 12 to make the height of the second end 1424 larger than the height of the first end 1422. In another embodiment, for the deformable rod 142 of each arm assembly 14, two ends may be flat and an intermediate connecting portion 1426 is bent. The bent intermediate connecting portion 1426 of the deformable rod 142 of each arm assembly 14 may make the height of the second end 1424 larger than the height of the first end 1422. For description purposes only, the embodiment in FIG. 1 where the deformable rod 142 of each arm assembly 14 has two flat ends and the bent intermediate connecting portion 1426 is used as an example to illustrate the present disclosure, and should not limit the scopes of the present disclosure. The joint parts of the intermediate connecting portion 1426 and two ends of deformable rod 142 may be curved to reduce the resistance induced by the intermediate connecting portion 1426 when the aerial vehicle 100 is flying.

The cross rod 144 of each arm assembly 14 may be used to accommodate propulsion components 20. When the aerial vehicle 100 is in the unfolded state, for the deformable rod 142 of each arm assembly 14, the second end 1424 may be away from the center frame 12, and the cross rod 144 rotatably connected to the second end 1424 may also be away from the center frame 12 with the second end 1424. Correspondingly, propulsion components 20 installed on the two cross rods 144 of the two arm assemblies 14 may also be away from the center frame 12.

In one embodiment, the two arm assemblies 14 may be symmetrically arranged along a rolling axis X of the center frame 12.

The symmetrical arrangement of the two arm assemblies 14 may make the structure of the deformable frame 10 more stable.

The deformable frame 10 may be applied to the aerial vehicle 100. When the aerial vehicle 100 flies and the deformable frame 10 is in the unfolded state, the symmetrical arrangement of the two arm assemblies 14 with respect to the center frame 10 may make the flight of the aerial vehicle more stable.

In one embodiment, the deformable frame 10 may further include a linkage synchronization mechanism 16 connecting the two arm assemblies 14. The two arm assemblies 14 may operate synchronously through the linkage synchronization mechanism 16.

In the present disclosure, the linkage synchronization mechanism 16 may make the two arm assemblies 14 may operate synchronously, to improve user experience.

In one embodiment the linkage synchronization mechanism 16 may synchronize the rotation of the deformable rods 142 of the two arm assemblies 14 with respect to the center frame 12. That is, when the deformable rod 142 of one arm assembly 14 rotates toward a direction away from the center frame 12, the deformable rod 142 of another arm assembly 14 may also rotate toward the direction away from the center frame 12; when the deformable rod 142 of one arm assembly 14 rotates toward the center frame 12, the deformable rod 142 of another arm assembly 14 may also rotate toward the center frame 12. Correspondingly, a user may operate the deformable rod 142 of one arm assembly 14 to rotate the deformable rods 142 of both two arm assemblies 14, and to switch the deformable frame 10 between the unfolded state and the folded state. The operation is simpler.

In one embodiment, the linkage synchronization mechanism 16 may include two gears 162 that are engaged with each other. The deformable rods 142 of the two arm assemblies 14 may be connected to the two gears respectively.

The setup of the two gears 162 may make the operation of the linkage synchronization mechanism 16 more stable.

In one embodiment, each of the two gears 162 may be connected to a first end 1422 of the deformable rod 142 of a corresponding arm assembly 14. Since the two gears 162 may be engaged with each other, when making one gear 162 and the deformable rod 142 of a corresponding arm assembly 14 connected to the gear 162 rotate, another gear 162 and the deformable rod 142 of a corresponding arm assembly 14 connected to the gear 162 may rotate correspondingly.

In some embodiments, to make the deformable frame 10 more compact, a curvature of a tooth portion of the gears 162 may be set according to a range of a rotation angle of the deformable rods 142 of the two arm assemblies 14. In one embodiment, the range of the rotation angle of the deformable rods 142 may be 90°, and the curvature of the tooth portion of the gears 162 may be larger than 90° and smaller than 360°, for example, larger than 90° and smaller than 95°.

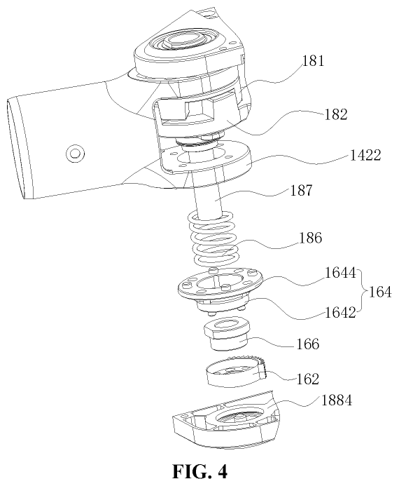

In one embodiment illustrated in FIG. 4, the linkage synchronization mechanism 16 may further include connecting parts 164. Each connecting part 164 may connect one gear 162 to the deformable rod 142 of a corresponding arm assembly 14. Each connecting part 164 may include a cylinder part 1642 and a flange part 1644 extending radially outward from the cylinder part 1642. The flange portion 1644 may be fixed to the first end 1422 of the deformable rod 142 of a corresponding arm assembly 14, and the cylinder part 1642 may be connected to the gear 162 to fixedly connect the gear 162 to the deformable rod 142 of the corresponding arm assembly 14.

In some other embodiments, the linkage synchronization mechanism 16 may include two sprockets connected by a chain. Each of the two deformable rods 142 may be connected to a corresponding sprocket.

The setup of the two sprockets may make the rotation of two arm assemblies synchronized.

The two sprockets may be connected by the chain, and a rotation direction of one sprocket may always be opposite to a rotation direction of another sprocket. The two sprockets may be engaged with the chain. Each of the two sprockets may be connected to the deformable rod 142 of a corresponding arm assembly 14. Since the two sprockets may be engaged with the chain, when making one sprocket and the deformable rod 142 of a corresponding arm assembly 14 connected to the sprocket rotate, another sprocket and the deformable rod 142 of a corresponding arm assembly 14 connected to the sprocket may rotate correspondingly.

In some other embodiments, the linkage synchronization mechanism 16 may include two pulleys. The two pulleys may be connected by a belt. Each of the two deformable rods 142 may be connected to a corresponding pulley.

The setup of the two pulleys may make the rotation of two arm assemblies synchronized.

The two pulleys may be connected by the belt, and a rotation direction of one pulley may always be opposite to a rotation direction of another pulley. The two pulleys may be engaged with each other by the belt. Each of the two pulleys may be connected to the deformable rod 142 of a corresponding arm assembly 14. Since the two pulleys may be engaged with the chain, when making one pulley and the deformable rod 142 of a corresponding arm assembly 14 connected to the pulley rotate, another pulley and the deformable rod 142 of a corresponding arm assembly 14 connected to the pulley may rotate correspondingly.

As illustrated in FIG. 2, in one embodiment, the deformable frame 10 may further include a locking mechanism 18 for limiting the rotation angle of the two arm assemblies 14. The locking mechanism 18 may be disposed between the arm assemblies 14 and the center frame 12, or may be connected between the arm assemblies 14 and the center frame 12.

When the deformable frame 10 is in the unfolded state or in the folded state, the locking mechanism 18 may lock the deformable rods 12 and the center frame 12, to fix the deformable rods 12 and the center frame 12. Correspondingly, a rotation of the deformable rods 12 with respect to the center frame 12 may be avoided, and the deformable 10 may remain in the unfolded state or in the folded state.

When the deformable frame 10 is switching between the unfolded state and the folded state, the lock of the deformable rods 142 and the center frame 12 by the locking mechanism 18 may be released. Correspondingly, the deformable rods 12 can rotate with respect to the center frame 12, and the deforming frame 10 can be folded or unfolded.

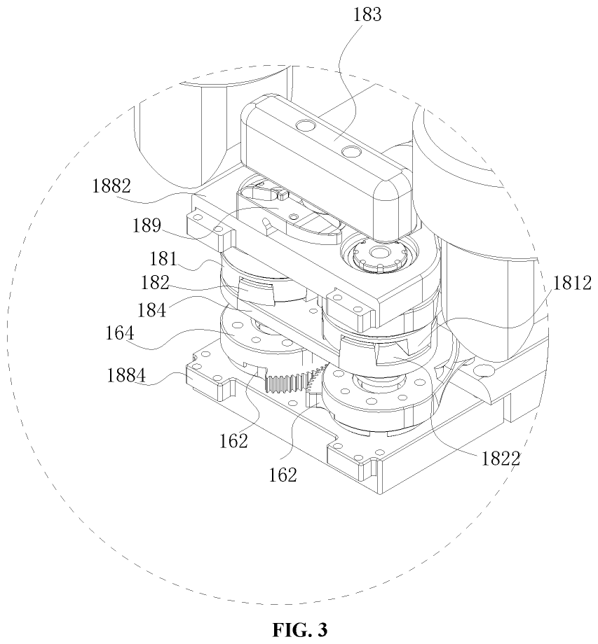

As illustrated in FIG. 3, in some embodiments, the locking mechanism 18 may include a rotation sprocket 181 and a limit sprocket 182. The deformable rods 142 may be connected to the rotation sprocket 181. When the deformable frame 10 is in the unfolded state or in the folded state, the rotation sprocket 181 may be engaged with the limit sprocket 182, to lock the deformable frame 10.

The rotation sprocket 181 may be engaged with the limit sprocket 182, to lock the deformable rods 142 and the deformable frame 10. Correspondingly, the position of the deformable rods 142 with respect to the deformable frame 10 may be fixed. The posture of the deformable frame 10 in the unfolded state or in the folded state may be more stable, and a rotation of the deformable rods 12 with respect to the center frame 12 may be avoided effectively.

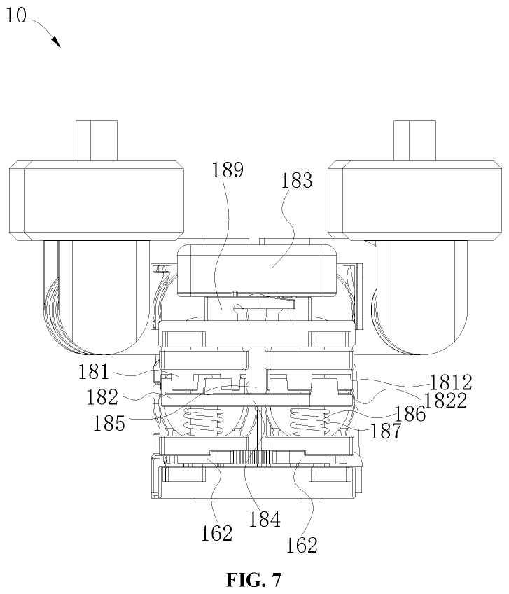

In some embodiments illustrated in FIG. 3 and FIG. 7, the rotation sprocket 181 may include limiting teeth 1812, and the limit sprocket 182 may include circular arc-shaped limiting slots 1822. The limiting teeth 1812 may be received in the limiting slots 1822 to make the rotation sprocket 181 and the limit sprocket 182 engaged with each other. Correspondingly, the rotation sprocket 181 and the limit sprocket 182 may be engaged with each other more stably.

A number of the limiting teeth 1812 may be plural, and the plurality of limiting teeth 1812 may be distributed along a circumferential direction of the rotation sprocket 181. A number of the limiting slots 1822 may be plural, and the plurality of limiting slots 1822 may be distributed along a circumferential direction of the limit sprocket 182. Each of the limiting teeth 1812 may be received in a corresponding limiting slot 1822. Correspondingly, the stability of the engagement between the rotation sprocket 181 and the limit sprocket 182 may be improved further.

When the number of the limiting teeth 1812 is plural, a limiting slot 1822 may be formed between two adjacent limiting teeth 1812. When the number of the limiting slots 1822 is plural, a limiting tooth 1812 may be formed between two adjacent limiting slots 1822. That is, the rotation sprocket 181 may include a plurality of limiting teeth 1812 and a plurality of limiting slots 1822, and the limit sprocket 182 may include a plurality of limiting teeth 1812 and a plurality of limiting slots 1822.

In various embodiments, the number of the limiting teeth 1812 and the number of the limiting slots 1822 may be configured according to actual needs. A shape of the limiting teeth 1812 and a shape of the limiting slots 1822 may be configured according to actual needs. In one embodiment, the shape of the limiting teeth 1812 may be configured to match the shape of the limiting slots 1822, to further improve the stability of the locking state of the connecting part 164 connecting the two arm assemblies 14 when the rotation sprocket 181 and the limit sprocket 182 is engaged with each other.

In some other embodiments, the limit sprocket 182 may include limiting teeth, and the rotation sprocket 181 may include arc-shaped limiting slots.

In one embodiment, the rotation sprocket 181 may rotate with respect to the limit sprocket 181 to a preset angle and then may be engaged with the limit sprocket 181 again, to make the deformable frame switch between the unfolded state and the folded state. Correspondingly, the deformable frame 10 may be folded or unfolded at different angles according to the preset angle, and may have a wide range of adjustable postures.

In various embodiments, the preset angle may be configured according to actual needs. When the rotation sprocket 181 is disengaged with the limit sprocket 181, the limiting teeth 1812 may be separated from the limiting slots 1822. Correspondingly, the rotation of the rotation sprocket 181 may not be limited by the limit sprocket 181, and the arm connecting parts 164 may be unlocked. The postures of the arm connecting parts 164 may be adjusted by rotating the arm connecting parts 164.

In one embodiment, the locking mechanism 18 may include an operation button 183 connected to the limit sprocket 182. The operation button 183 may be switched between a first position and a second position. When the operation button 183 is in the first position, the rotation sprocket 181 may be engaged with the limit sprocket 181. When the operation button 183 is in the second position, the rotation sprocket 181 may be separated from the limit sprocket 182.

A user may lock or unlock the deformable frame 10 by the operation button 183. An operability of the deformable frame 10 and the user experience may be improved.

In one embodiment, the operation button 183 may be pressed to switch between the first position and the second position, and the first position and the second position may be two positions along the height direction of the center frame 12. An operation of the operation button 183 may be facilitated. For description purposes only, the embodiment where the first position and the second position are two positions along the height direction of the center frame 12 is used as an example to illustrate the present disclosure, and should not limit the scopes of the present disclosure. In various embodiments, the first position and the second position may not be limited to two positions along the height direction of the center frame 12, but may be any suitable positions. For example, in another embodiment, the first position and the second position may be two positions along a direction perpendicular to the height direction of the center frame 12. In another embodiment, the first position of the operation button 183 may be any position of the operation button 183 as long as the rotation sprocket 181 is engaged with the limit sprocket 181.

In another embodiment, the locking mechanism 18 may include two limit sprockets 182, and the two limit sprockets 182 may be connected to the first ends of the two deformable rods 1422 respectively. The two limit sprockets 182 may be connected to each other by a connecting plate 184. The locking mechanism 18 may further include a press rod 185. The press rod 185 may connect the operation button 183 to the connecting plate 184. As illustrated in FIG. 7, when the operation button 183 at the second position moves downward along the axial direction of the press rod 185 to press the connecting plate 184, the connecting plate 184 may move downward to drive the limit sprockets 182 to move downward. Correspondingly, the limit sprockets 182 and the rotation sprocket 181. When the operation button 183 at the first position moves upward along the axial direction of the press rod 185 to press the connecting plate 184, the connecting plate 184 may move upward to drive the limit sprockets 182 to move upward. Correspondingly, the limit sprockets 182 may be engaged with the rotation sprocket 181.

In some embodiments, the locking mechanism 18 may further include an elastic part 186. The elastic part 186 may abut between the limit sprockets 182 and the center frame 12, and may be configured to drive the limit sprockets 182 to be engaged with the rotation sprocket 181.

The elastic part 186 may be in a pre-pressed state, and may be abutted against the limit sprockets 182 to make the limit sprockets 182 being engaged with the rotation sprocket 181. Correspondingly, the deformable frame 10 may keep stable when the deformable frame 10 is in the locked state.

When the limit sprockets 182 are separated from the rotation sprocket 181, the deformable rods 142 may rotate with respect to the center frame 12, to make the limit sprockets 182 rotate by a preset angle with respect to the rotation sprocket 181. The limit sprockets 182 may be engaged with the rotation sprocket 181 by the elastic part 186 in the pre-pressed state. The elastic part 186 in the pre-pressed state may make the engagement between the limit sprockets 182 and the rotation sprocket 181 stable.

When the operation button 183 is in the second position, the limiting teeth 1812 may leave the limiting slots 1822 and may be abutted against a top surface of the limit sprocket 182. Correspondingly, the elastic part 186 may be compressed and contract to be in a compressed state. When the deformable rods 142 are rotated to make the limiting teeth 1812 leave the top surface of the limit sprocket 182, the elastic part 186 in the compressed state may be elongated to drive the limit sprocket 182 to move upward along the axial direction of the press rod 185. Correspondingly, the limiting teeth 1812 may be re-accommodated in the limiting slots 1822 and the rotation sprocket 181 may be re-engaged with the limit sprocket 182. The rotation sprocket 181 may be engaged with the limit sprocket 182 in a simple way through the elastic part 186.

When the operation button 183 is in the second position, the elastic part 186 may drive the limit sprocket 182, the press plate 184, and the operation button 183 to move upward along the axial direction of the press rod 185. The limit sprocket 182 driven by the elastic part 186 may move upward to be engaged with the rotation sprocket 181, and the operation button 183 may move to the first position.

In some embodiments, the elastic part 186 may be a spring, and may have great elasticity. In some other embodiments, the elastic part 186 may be any other elastic part that meet the elastic requirement.

In some embodiment, the locking mechanism 18 may include a support shaft 187 connecting the center frame 12 to the deformable rods 142. The rotation sprocket 181 may be rotatably sleeved on the support shaft 187, and the limit sprocket 182 may be rotatably sleeved on the support shaft 187, and the elastic part 186 may be sleeved on the support shaft 187. Correspondingly, the deformable rods 142 may rotate more stably, and the elastic part 186 may apply a driving force to the limit sprocket 182 more stably.

The support shaft 187 may penetrate through the limit sprocket 182, and the limit sprocket 182 may move up and down along an axial direction of the support shaft 187. Correspondingly, the moving positions of the limit sprocket 182 may be fixed, and limit sprocket 182 and the rotation sprocket 181 may be engaged and disengaged with each other easily.

As illustrated in FIGS. 6-7, in some embodiments, the locking mechanism 18 may include a fixing assembly 188, and the fixing assembly 188 may include a fixing upper plate 1882 and a fixing lower plate 1884. The two deformable rods 142 of the two arm assemblies 14 may be rotatably connected to the fixing upper plate 1882. The fixing upper plate 1882 and the fixing lower plate 1884 may be disposed on two ends of the support shaft 187 respectively. The fixing lower plate 1884 may be connected to the center frame 12. The rotation sprocket 181 and the limit sprocket 182 may be disposed between the fixing upper plate 1882 and the fixing lower plate 1884. Correspondingly, the fixing upper plate 1882 and the fixing lower plate 1884 may limit the position of the upper side and the lower side of the deformable rods 142, to improve the stability of the deformable rods 142 when rotating.

An upper end of the support shaft 187 may be connected to the fixing upper plate 1882 by an upper bearing, and a lower end of the support shaft 187 may be connected to the fixing lower plate 1884 by a lower bearing. The fixing lower plate 1884 may be connected to an end of the center frame 12.

In some embodiments, a position-limiting plate 189 may be disposed on the fixing upper plate 1882 to limit the operation button 183 in the first position. Correspondingly, the position-limiting plate 189 may make the position of the operation button 183 in the first position more stable, to make the limit sprocket 182 and the rotation sprocket 181 keep engaged. The deformable frame 10 may be more stable in the unfolded and folded state.

When the operation button 183 is in the first position, the limit sprocket 182 may be engaged with the rotation sprocket 181. The locking mechanism 18 may be in the locking state and the deformable frame 10 may be locked. The limit plate 189 may be located under the operation button 183 (that is, the operation button 183 may further rotate by an appropriate angle with respect to the position in FIG. 3, to be located above the limit plate 189), and the operation button 183 cannot be pressed down, and may be limited in the first position. A false triggering of the operation button 183 and then an unexpected unlocking of the deformable frame 10 may be avoided.

When unlocking is needed, the operation button 183 may be rotated to leave the limit plate 189, as illustrated in FIG. 3 and FIG. 7. The operation button 183 then may be pressed to separate the limit sprocket 182 from the rotation sprocket 181. The elastic component 186 may be compressed. When the force for pressing the operation button 183 is removed, the elastic component 186 may drive the limit sprocket 183 to be re-engaged with the rotation sprocket 181. Correspondingly, the deformable frame 10 may be locked again.

When the operation button 183 is in the first position, the operation button 183 may be in contact with the limit plate 189, and the contacting interface between the operation button 183 and the limit plate 189 may be rough. When the operation button 183 is touched accidentally, a static frictional force may be generated between the operation button 183 and the limit plate 189 to prevent the operation button 183 from moving. An accidental movement of the operation button 183 may be avoided. When a user applies an external force larger than the maximum static frictional force to rotate the operation button 183, the operation button 183 may rotate and the limit plate 189 may form a sliding friction force on the operation button 183 along a direction opposite to a moving direction of the operation button 183, to prevent the operation button 183 from sliding in or out of the limit plate 189 too fast. The stability of the locking mechanism 18 as a whole may be improved.

In one embodiment, the operation button 183 may be located in the first position including the position of the operation button 183 in FIG. 3, a position of the operation button 183 above the limit plate 189 (that is, a position of the operation button 183 being further rotated by an appropriate angle with respect to the position in FIG. 3), and other positions of the operation button 183 corresponding to the engaged limit sprocket 182 and the rotation sprocket 183. An end of the press prod 183 may be rotatably connected to the operation button 183.

As illustrated in FIG. 1, in some embodiments, each arm assembly 14 may include two deformable rod 142. When the deformable frame 10 is unfolded, the two arm assemblies 14 and the center frame 12 may form a parallelogram structure. Correspondingly, the structure of the deformable frame 10 in the unfolded state may be more stable.

Each arm assembly 14 may include two deformable rods 142 and one cross rod 144. One end of each deformable rod 142 may be rotatably connected to the center frame 12, and another end may be rotatably connected to the cross rod 144. When the deformable frame 10 is unfolded, the two deformable rods 142 of each arm assembly 14 may be parallel to each other, and the cross rod 144 may be parallel to the rolling axis X of the center frame 12.

For the description purposes only, the embodiment where each arm assembly 14 includes two deformable rods 142 is used as an example to illustrate the present disclosure, and should not limit the scopes of the present disclosure. In various embodiments, each arm assembly 14 may include one or another number of deformable rods 142.

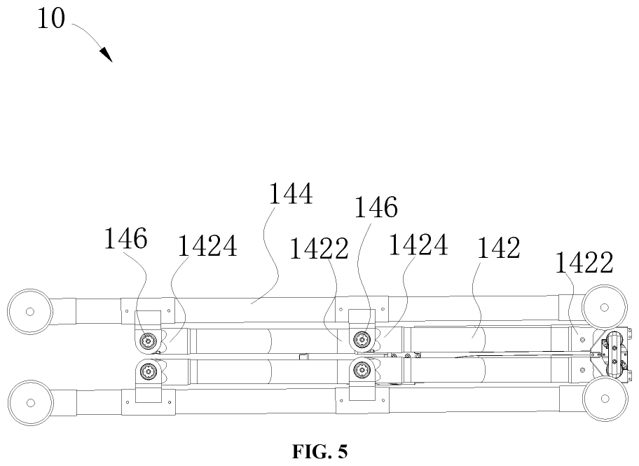

As illustrated in FIG. 2, FIG. 5, and FIG. 6, in some embodiments, when the deformable frame 10 is folded, each deformable rod 142 may be stacked above the center frame 12, and the cross rods 144 may be parallel to the deformable rods 142. Correspondingly, the volume occupied by the deformable frame 10 in the folded state may be further reduced, and the deformable frame 10 may be carried or transported more easily.

In one arm assembly 14, when the cross rod 144 is parallel to the deformable rods 142, an angle between the cross rod 144 and the deformable rods 142 may be 0, and the cross rod 144 may be in close contact with the deformable rods 142. The volume occupied by the deformable frame 10 may be further reduced. The cross rod 144 may be also parallel to the center frame 12.

In one embodiment, each arm assembly 14 may include two deformable rods 142, and a height of the ends of the two deformable rods 142 may be different. Correspondingly, when the deformable frame 10 is folded, the two deformable rods 142 of each arm assembly 14 may be stacked together. Correspondingly, the volume occupied by the deformable frame 10 in the folded state may be further reduced.

In one arm assembly 14, a second end 1424 of one deformable rod 142 and a first end 1422 of another deformable rod 142 may have different height. When the deformable frame 10 is folded, a second end 1424 of one deformable rod 142 and a first end 1422 of another deformable rod 142 may be stacked together. Further, a first end 1422 of one deformable rod 142 and a first end 1422 of another deformable 142 may have same height, and a second end 1424 of one deformable rod 142 and a second end 1424 of another deformable 142 may have same height.

In some embodiments, when the deformable frame 10 is folded, in each arm assembly 14, a jointing position between the cross rod 144 and one deformable rod 142 may be located directly above a jointing position between another deformable rod 142 and the center frame 12. Correspondingly, a length of the volume occupied by the deformable frame 10 may be reduced effectively.

In one embodiment, for each arm assembly 14, a second end 1424 of one deformable rod 142 may be higher than a first end 1422 of another deformable rod 142. When the deformable frame 10 is folded, a second end 1424 of one deformable rod 142 may be stacked directly above a first end 1422 of another deformable rod 142.

In some embodiments, a distance L1 between two deformable rods 142 in each arm assembly 14 may be smaller than a length L2 of the deformable rods 142.

Correspondingly, when the deformable frame 10 is folded, the two deformable rods 142 of each arm assembly 14 may be stacked together. Correspondingly, the length of the volume occupied by the deformable frame 10 may be further reduced.

L1 may be a distance between ends of the first ends 1422 of the two deformable rods 142 of one arm assembly 14, and L2 may be a distance between a head and a tail of a deformable rod 142.

In some embodiments, the cross rod 144 and the deformable rods 142 of each arm assembly 14 may have different height.

Correspondingly, in each arm assembly 14, the cross rod 144 and the deformable rods 142 may be disposed in different layers. When the deformable frame 10 is folded, the two deformable rods 142 and the cross rod 144 in each arm assembly 14 may be stacked together. Correspondingly, the width of the volume occupied by the deformable frame 10 may be further reduced.

In one embodiment, the height of the cross rod 144 is larger than the height of the deformable rods 142 in each arm assembly 14. When the deformable frame 10 is folded, the cross rod 144 in each arm assembly 14 may be stacked above the two deformable rods 142. Correspondingly, the width of the volume occupied by the deformable frame 10 may be effectively reduced.

In another embodiment, the height of the deformable rods 142 is larger than the height of the cross rod 144 in each arm assembly 14. When the deformable frame 10 is folded, the deformable rods 142 may be stacked above the cross rod 144. Correspondingly, the width of the volume occupied by the deformable frame 10 may be effectively reduced.

In one embodiment, the cross rods 144 of the two arm assemblies 14 may be parallel to each other. Correspondingly, the flight of the aerial vehicle 100 may be more stable.

In some embodiments, each arm assembly 14 may further include a rotating pair 146 connecting the deformable rods 142 to the cross rod 144.

The rotating pair 145 may rotatably connect the deformable rods 142 to the cross rod 144.

In some embodiments, each arm assembly 14 may include two deformable rods 142, and two rotating pairs 146 may be disposed at the cross rod 144. Each deformable rod 142 may be connected to the cross rod 144 through a corresponding rotating pair 146. The two rotating pairs 146 may be both disposed at the upper side or at the lower side of the cross rod 144.

By disposing the two rotating pairs 146 at the upper side or at the lower side of the cross rod 144, the rotating pairs 146 may not increase the width of the volume occupied by the deformable frame 10 when the deformable frame 10 is folded. The volume occupied by the deformable frame 10 when the deformable frame 10 may be reduced.

The two rotating pairs 146 may be both disposed at the upper side or at the lower side of the cross rod 144.

In some other embodiments, each arm assembly 14 may include two deformable rods 142, and two rotating pairs 146 may be disposed at the cross rod 144. Each deformable rod 142 may be connected to the cross rod 144 through a corresponding rotating pair 146. The two rotating pairs 146 may be disposed at the upper side or at the lower side of the cross rod 144 respectively.

By disposing the two rotating pairs 146 at the upper side or at the lower side of the cross rod 144 respectively, the rotating pairs 146 may not increase the width of the volume occupied by the deformable frame 10 when the deformable frame 10 is folded. The volume occupied by the deformable frame 10 when the deformable frame 10 may be reduced.

In some other embodiments, each arm assembly 14 may further include the rotating pairs 146 connecting the deformable rods 142 to the cross rod 144. The rotating pairs 146 may be disposed at an inner side of the cross rod 144. The structure of the deformable frame 10 may be more stable.

When the deformable frame 10 is folded, a rotating pair 146 connected to the second end 1424 of a deformable rod 142 may be located above the first end 1422 of another deformable rod 142. Correspondingly, the rotating pairs 146 may not increase the width of the volume occupied by the deformable frame 10.

In one embodiment, the deformable frame 10 may include a driving part. The driving part may be connected to the deformable rods 142, and may be configured to drive the deformable rods 142 to rotate, to make the deformable frame 10 switch between the unfolded state and the folded state.

The driving part may make the deformable frame 10 switch between the unfolded state and the folded state automatically. There may be no need for the user to manually operate the arm assemblies 14. The user experience may be improved.

The driving part may include a motor. An output shaft of the motor may output the driving force to the deformable rods 142 through a transmission part (such as a gear, a belt, a chain). Correspondingly, the deformable rods 142 may rotate with respect to the center frame 12 to switch between the unfolded state and the folded state.

The present disclosure also provides an aerial vehicle 100. The aerial vehicle 100 may include a deformable frame 10 provided by various embodiments of the present disclosure. Loadings may be disposed on the center frame 12.

In the aerial vehicle 199, the deformable frame 10 may be folded to a stack structure when the deformable frame 10 changes from the unfolded state to the folded state. The deformable frame 10 in the folded state may occupy a small volume, and may be easy to carry and transport.

The aerial vehicle 100 may be a multi-rotor aerial vehicle, and may be used for aerial photography, mapping, plant protection, fire protection, and the like. The aerial vehicle 100 may be easy to carry and operate, and may have a relatively low cost.

In some embodiments, the aerial vehicle 100 may further include propulsion assemblies 20 on the cross rods 144.

The propulsion assemblies 20 may provide propulsion to the aerial vehicle 100.

In various embodiments, the aerial vehicle 100 may include a different number of propulsion assemblies 20. For example, the aerial vehicle 100 may include one, two, three, four, five, or six propulsion assemblies 20. In one embodiment, the aerial vehicle 100 may include four propulsion assemblies 20. Each arm assembly 14 may include one cross rod 144, and one propulsion assembly 20 may be disposed at each end of each cross rod 144. When the deformable frame 10 is folded, the propulsion assemblies 20 may be folded with the cross rods 144, and the deformable frame 10 may be easy to carry and transport. When the deformable frame 10 is unfolded, the propulsion assemblies 20 with the cross rods 144 may protrude out away from the center frame 12, to provide propulsion to the aerial vehicle 100.

In some embodiments, each propulsion assembly 20 may include a motor 22 and a propeller 24. The motor 22 may be disposed at a corresponding cross rod 144, and the propeller 24 may be connected to the motor 22. The motor 22 may drive the propeller 24 to provide propulsion to the aerial vehicle 100.

In some embodiments, the aerial vehicle 100 may include a plurality of propellers 24. The speed and direction of the aerial vehicle 100 may be controlled by adjusting the rotation speed of the plurality of propellers 24.

In some embodiments, the loading may include a gimbal and/or a camera. The aerial vehicle 100 may be equipped with other devices through the gimbal, and may collect images by the camera. The function of the aerial vehicle 100 may be enriched and the application of the aerial vehicle 100 may be expanded.

The gimbal may be mounted on the center frame 12 and the camera may be mounted on the gimbal. In another embodiment, the camera may be mounted on the center frame 12 directly.

The loading may include a gimbal and/or a camera. In one embodiment, the loading may include the gimbal and the gimbal may be equipped with other devices. In one of other embodiments, the loading may include the camera mounted on the center frame 12. In another embodiment, the loading may include the gimbal and the camera. The gimbal may be equipped with the camera and other devices, or the gimbal may be equipped with other devices and the camera may be mounted on the center frame 12.

Those of ordinary skill in the art will appreciate that the example elements and algorithm steps described above can be implemented in electronic hardware, or in a combination of computer software and electronic hardware. Whether these functions are implemented in hardware or software depends on the specific application and design constraints of the technical solution. One of ordinary skill in the art can use different methods to implement the described functions for different application scenarios, but such implementations should not be considered as beyond the scope of the present disclosure.

For simplification purposes, detailed descriptions of the operations of example systems, devices, and units may be omitted and references can be made to the descriptions of the example methods.

The disclosed systems, apparatuses, and methods may be implemented in other manners not described here. For example, the devices described above are merely illustrative. For example, the division of units may only be a logical function division, and there may be other ways of dividing the units. For example, multiple units or components may be combined or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit.

A method consistent with the disclosure can be implemented in the form of computer program stored in a non-transitory computer-readable storage medium, which can be sold or used as a standalone product. The computer program can include instructions that enable a computer device, such as a personal computer, a server, or a network device, to perform part or all of a method consistent with the disclosure, such as one of the example methods described above. The storage medium can be any medium that can store program codes, for example, a USB disk, a mobile hard disk, a read-only memory (ROM), a random access memory (RAM), a magnetic disk, or an optical disk.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the disclosure. Thus, while the present disclosure has been described in detail with reference to the above described embodiments, the present disclosure is not limited to the above described embodiments but may be embodied in other equivalent forms without departing from the scope of the present disclosure, which is determined by the appended claims.

What is claimed is:

1. An aerial vehicle, comprising:
a deformable frame, including:
a center frame and two arm assemblies, wherein:
the two arm assemblies are disposed at two sides of the center frame respectively;
the two arm assemblies are rotatably connected to the center frame, to enable the deformable frame to switch between an unfolded state and a folded state;
each arm assembly includes a deformable rod and a cross rod;
the deformable rod includes a first end rotatably connected to the center frame, and a second end rotatably connected to the cross rod;
a height of the second end is larger than a height of the first end;
in the unfolded state, second ends of the deformable rods in the two arm assemblies are away from the center frame; and
in the folded state, the deformable rods in the two arm assemblies are stacked above the center frame; and
a loading, mounted on the center frame.

2. The aerial vehicle according to claim 1, wherein the two arm assemblies are disposed symmetrically with respect to a horizontal roll axis of the center frame.

3. The aerial vehicle according to claim 1, wherein the deformable frame further includes a linkage synchronization mechanism, wherein moving of the two arm assemblies are linked by the linkage synchronization mechanism.

4. The aerial vehicle according to claim 3, wherein:
the linkage synchronization mechanism includes two gears engaged with each other; and
the deformable rods of the two arm assemblies are connected to the two gears respectively.

5. The aerial vehicle according to claim 3, wherein:
the linkage synchronization mechanism includes two sprocket wheels connected to each other through a chain; and
the deformable rods of the two arm assemblies are connected to the two sprocket wheels respectively.

6. The aerial vehicle according to claim 3, wherein:
the linkage synchronization mechanism includes two pulleys connected to each other through a belt; and
the deformable rods of the two arm assemblies are connected to the two pulleys respectively.

7. The aerial vehicle according to claim 1, wherein the deformable frame further includes a locking mechanism to limit a rotation angle of the two arm assemblies, wherein:
the locking mechanism is disposed between the two arm assemblies and the center frame, or between the two arm assemblies.

8. The aerial vehicle according to claim 7, wherein:
the locking mechanism includes a rotation sprocket and a limit sprocket;
the rotation sprocket and the limit sprocket can be engaged with each other;
the deformable rods are connected to the rotation sprocket; and
when the deformable frame is in the unfolded state and in the folded state, the rotation sprocket and the limit sprocket are engaged with each other to lock the deformable frame.

9. The aerial vehicle according to claim 8, wherein:
the rotation sprocket includes limit teeth and the limit sprocket includes arc-shaped limit slots, or the rotation sprocket includes arc-shaped limit slots and the limit sprocket includes limit teeth; and
the limit teeth are received in the limit slots, to make the rotation sprocket engaged with the limit sprocket.

10. The aerial vehicle according to claim 8, wherein:
the rotation sprocket rotates by a preset angle with respect to the limit sprocket and then is re-engaged with the limit sprocket, to make the deformable frame switch between an unfolded state and a folded state.

11. The aerial vehicle according to claim 8, wherein:
the locking mechanism includes an operation button connected to the limit sprocket;
the operation button can switch between a first position and a second position;
when the operation is in the first position, the rotation sprocket and the limit sprocket are engaged with each other; and
when the operation is in the second position, the rotation sprocket is separated from the limit sprocket.

12. The aerial vehicle according to claim 11, wherein:
the locking mechanism includes an elastic part;
the elastic part is abutted between the limit sprocket and the center frame, and is configured to drive the limit sprocket to be engaged with the rotation sprocket.

13. The aerial vehicle according to claim 12, wherein:
the locking mechanism includes a support shaft connecting the center frame and the deformable rods;
the rotation sprocket is rotatably sleeved on the support shaft;
the limit sprocket is rotatably sleeved on the support shaft; and
the elastic part is sleeved on the support shaft.

14. The aerial vehicle according to claim 13, wherein:
the locking mechanism includes a fixing assembly;
the fixing assembly includes a fixing upper plate and a fixing lower plate;
the two deformable rods of the two arm assemblies are rotatably connected to the fixing upper plate;
the fixing upper plate and the fixing lower plate are disposed at two ends of the support shaft respectively;
the fixing lower shaft is connected to the center frame; and
the rotation sprocket and the limit sprocket are located between the fixing upper plate and the fixing lower plate.

15. The aerial vehicle according to claim 14, wherein:
a limit plate is disposed at the fixing upper plate to limit the operation button in the first position.

16. The aerial vehicle according to claim 1, wherein:
each arm assembly includes two of the deformable rod; and
when the deformable frame is in the unfolded state, the two arm assemblies and the center frame form a parallelogram structure.

17. The aerial vehicle according to claim 16, wherein:
when the deformable frame is in the folded state, the deformable rods are stacked above the center frame, and the cross rods are parallel to the deformable rods.

18. The aerial vehicle according to claim 1, wherein:
each arm assembly includes two of the deformable rod, and height of the ends of the two of deformable rod is different;
wherein:
when the deformable frame is in the folded state, in each arm assembly, a connecting point between one deformable rod and the cross rod is located directly above a connecting point between another deformable rod and the center frame.

19. The aerial vehicle according to claim 1, wherein:
a height of the deformable rod is different from a height of the cross rod; and
the cross rods of the two arm assemblies are parallel to each other.

20. The aerial vehicle according to claim 1, wherein:
each arm assembly includes a rotation pair on the cross rod; and
the rotation pair connects the deformable rod and the cross rod.
